(19) United States
(12) Patent Application Publication
(10) Pub. No.: US 2020/0063897 A1
(43) Pub. Date: Feb. 27, 2020

(54) THERMALLY DECOUPLED PIPE BRACKET WITH HIGH MECHANICAL LOADING CAPACITY

(71) Applicant: BASF SE, Ludwigshafen am Rhein (DE)

(72) Inventors: Ishak KURT, Ludwigshafen (DE); Ralf DEBOLD, Ludwigshafen (DE); Stefan HOFFMANN, Ludwigshafen (DE); Sebastian STUPPY, Ludwigshafen (DE)

(73) Assignee: BASF SE, Ludwigshafen am Rhein (DE)

(21) Appl. No.: 16/466,233

(22) PCT Filed: Dec. 14, 2017
(86) PCT No.: PCT/EP2017/082754

§ 371 Date: Jun. 3, 2019

(30) Foreign Application Priority Data
Dec. 22, 2016 (DE) 10 2016 226 024.3

(51) Int. Cl. F16L 3/10; F16L 3/24; F16L 59/135

(52) U.S. Cl. CPC F16L 3/1016; F16L 59/135; F16L 3/24

(57) ABSTRACT

The invention relates to a pipe holder for mounting a pipe on a bearing, comprising two foot supports which are mutually spaced apart and are in each case capable of being connected to the bearing; a support element having a web, a pipe receptacle at the upper end of the web, and a foot part at the lower end of the web, wherein the foot part is disposed in the intermediate space between the foot supports; as well as at least one pressure-resistant insulating element which is disposed between the first foot support and the foot part as well as between the second foot support and the foot part of the support element, wherein the foot supports, the insulating elements, and the foot part are connected to one another in a force-fitting manner by way of at least one fastening element.

The invention relates to a pipe holder for mounting a pipe on a bearing, comprising two foot supports which are mutually spaced apart and are in each case capable of being connected to the bearing; a support element having a web, a pipe receptacle at the upper end of the web, and a foot part at the lower end of the web, wherein the foot part is disposed in the intermediate space between the foot supports; as well as at least one pressure-resistant insulating element which is disposed between the first foot support and the foot part as well as between the second foot support and the foot part, wherein the foot supports, the insulating element, and the foot part are connected to one another in a force-fitting manner by way of at least one fastening element.

Generic pipe holders are used in various applications. Pipe holders of this type are often used in particular when applied in power station technology or the processing industry in order to fasten pipelines through which hot media flow to parts of the plant or to infrastructural installations. Fluid media of which the temperature in the pipeline is higher than the temperature of the environment around the pipeline are referred to as hot in this context. There is the requirement for minimizing as far as possible the heat transfer from the medium transported in the pipeline to the environment in particular with a view to energy efficiency, but in many cases also for safety reasons, for example in potentially explosive environments. The pipe holders which represent the connection between the pipeline and the bearing face of the component to which the pipeline is fastened are particularly relevant in this context.

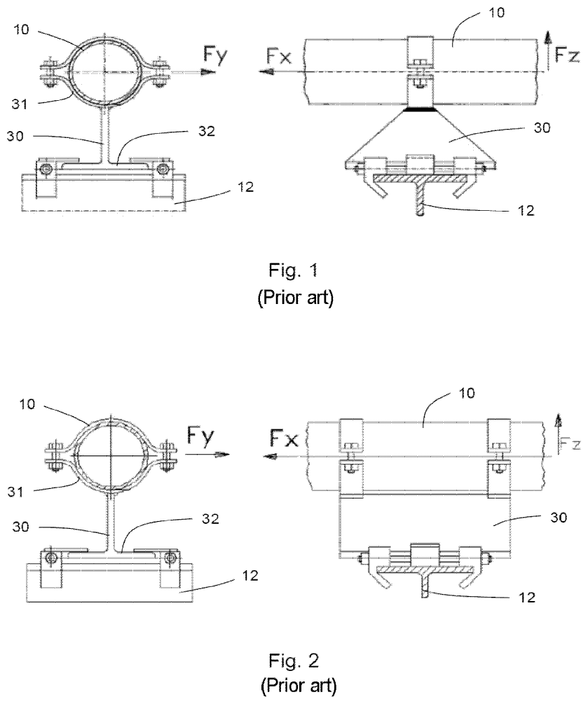

Pipe holders from steel which are fastened directly to both the pipeline as well as to the bearing face are still widely used in the prior art. Examples of pipe holders of this type are illustrated in FIGS. 1 and 2. The heat transfer by virtue of the high thermal conductivity of the steel material is accordingly high in these cases.

In order to achieve a reduction in the heat transfer it is known in the prior art for a layer of thermally insulating material to be provided at the connection points, for example between the pipeline and the pipe holder, or between the pipe holder and the bearing face of the component to which the pipe holder is fastened. This measure does indeed lead to a reduction in the heat transfer from the medium to the environment, but constructions of this type are often unfavorable in terms of production technology or for cost reasons. A further disadvantage is to be seen in that the insulation materials used are often less rigid and torsionally stiff than the material of the pipe holder, this leading to the entire system of the pipe mounting being able to absorb lower loads as compared to the non-insulated variant. Depending on the loads to be absorbed, the latter being substantially a function of the pipe diameter, the pipe geometry, the material selection, and the medium flowing through the pipe, pipe holders insulated in such a manner can only be used as a floating bearing but not as a fixed bearing, which would also be capable of absorbing significant forces in the direction of the pipeline axis.

While a floating bearing permits a movement of the pipe in all spatial directions, including the pipe being lifted from the holder, a guide bearing permits only a movement in the direction of the pipe axis. Transverse movements, just like lifting of the pipe from the holder, herein are prevented by mounts of the pipe. In the case of a fixed bearing the movement in the direction of the pipe axis is finally also suppressed, this usually being achieved by a force-fitting connection between the pipe and the pipe holder.

A pipe holder system which in principle is also suitable as a fixed bearing and herein displays good thermal insulation is described in first and unexamined publication DE 10 2014 109 599 A1. The pipeline herein is held by a support bearing which is composed of two formed parts which are connected to one another in a force-fitting and form-fitting manner. The advantage of the more simple production of said formed parts which can be punched and bent from a sheet metal, for example, is however associated with a reduction in terms of the mechanical stability at high axial and radial loads.

There was therefore the object of refining generic pipe holders in such a manner that the heat transfer from the medium transported in the pipeline to the environment is further reduced, on the one hand, and the pipe holder also withstands high mechanical loads in the axial direction as well as radial and transverse loads on the other hand. Moreover, the pipe holder is to be simple to make and cost-effective in terms of production.

This object is solved according to the invention by a pipe holder according to claim 1. Advantageous design embodiments of the pipe holder are stated in claims 2 to 10.

The pipe holder according to the invention for mounting a pipe on a bearing comprises two foot supports which are mutually spaced apart and are in each case capable of being connected to the bearing. Said pipe holder according to the invention furthermore comprises a support element having a web, a pipe receptacle at the upper end of the web, and a foot part at the lower end of the web, wherein the foot part is disposed in the intermediate space between the foot supports. The pipe receptacle, the web, and the foot part are configured so as to be integral or are connected to one another in a materially integral manner, for example welded. This has the advantage that the support element and thus the entire pipe holder can absorb higher forces than a pipe holder of which the support element is composed of a plurality of components, as is known, for example, from document DE 10 2014 109 599 A1.

The pipe holder furthermore comprises at least one pressure-resistant insulating element which is disposed between the first foot support and the foot part as well as between the second foot support and the foot part. The foot supports, the insulating element, and the foot part of the support element are connected to one another in a force-fitting manner by way of at least one fastening element.

The pipe holder is designed according to the invention so as to withstand a breaking load (according to appendix J of DIN EN 13480-3:2013-11) of at least 2.8 kN. This design requires the materials to be used for the production of the pipe holder and the dimensions of said materials, for example the wall thickness of flat metal sheets or angled profile metal sheets to be established. Corresponding materials and calculating methods for the design are known to a person skilled in the art.

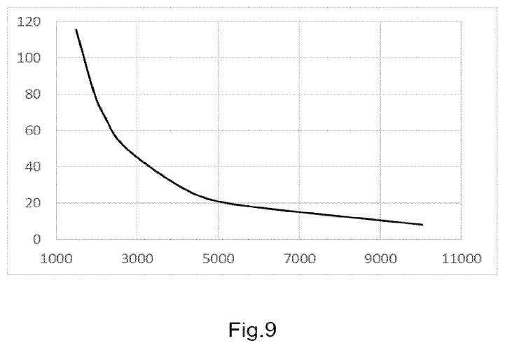

According to the invention, the bearing face (referred to as “A” and indicated in [mm²]) of the insulating element on the foot part and the cold-pressure resistance (referred to as “K” and indicated in [N/mm²) of the insulating element meet the condition: K>3·10⁶·A^{(-1.39)}. (Alternative notation: K>3·1.0e6·A\hat{ }(−1.39)). FIG. 9 shows the graphic profile, wherein the bearing face in mm² is displayed on the abscissa, and the cold-pressure resistance in N/mm² is displayed on the ordinate. The term “bearing face (A)” herein is to be understood as the face on which the insulating element on the foot part of the support element bears in a fully planar manner. In the case of embodiments in which the insulating elements and the foot part bear on a plurality of discrete faces, the sum of said faces forms the bearing face to be used in the condition above. Since the insulating element or a plurality of insulating elements is or are present both between the foot part and the first foot support, as well as between the foot part and the second foot support, there are also two bearing faces. The latter are however not added for consideration in the above condition, but the respective smaller of said two bearing faces is used. In the case of embodiments in which the bearing face of the insulating element on the foot part is larger than the corresponding bearing face of the insulating element on the foot support, the smaller bearing face of the foot support is to be used.

The above-mentioned condition according to the invention takes into account that the pipe holder is designed for a breaking load of at least 2.8 kN. For holders which are designed for a minimum breaking load of 6.4 kN, in particular holders having two separate pipe receptacles, it is preferable for the condition K>2·10⁶·A^{(-1.28)} to be met, wherein K and A have the same significance as in the condition above. (Alternative notation: K>2·1.0e6·A\hat{ }(−1.28)).

A choice of the bearing face in the region according to the invention as a function of the cold-pressure resistance of a selected insulating material has the effect that sufficient forces can be transmitted in the axial and radial direction, without damage to the insulating element arising. Furthermore, the bearing face required for the transmission of force can be minimized as a function of the selected insulating material, this contributing toward a desired reduction of the heat loss by way of the pipe holder.

The pipe holder according to the invention is suitable for receiving all pipes that are commonplace in the processing industry or in power station technology. Since said pipe holder is capable of high mechanical load, said pipe holder is particularly suitable for pipelines having a nominal diameter in the range from DN 10 to DN 300 mm. The nominal diameter (DN) herein relates to the definition in Public Available Specification PAS 1057-1 “Pipe Classes for Process Plants”, based on standard DIN EN 13480.

The pipe holder can be attached to all usual bearings, for example to steel supports. The fastening of the pipe holder to the bearing is performed by way of the foot supports and by way of a corresponding design embodiment of the foot supports can be adapted to various situations.

The support element at the upper end thereof is configured as a pipe receptacle for receiving the pipe in a bearing manner. The bearing receptacle can be designed in the usual manner, for example in the shape of a pipe bracket. The pipe is preferably fastened directly to the pipe receptacle. This does indeed have the disadvantage that a heat transfer from the pipe external wall to the support element takes place but has the advantage that comparatively high forces can be transmitted, or that the pipe in the position thereof can be better stabilized. With a view to an ideally minor heat transfer from the pipe to the pipe holder, the axial extent of the pipe receptacle is preferably not more than 150 mm, particularly preferably not more than 100 mm, in particular not more than 50 mm per pipe receptacle.

The support element is of particular relevance in terms of the mechanical stability of the pipe holder. The support element preferably has an elongation limit R_{p0.2} (according to DIN EN 10088-3) of at least 190 MPa. These value ranges guarantee sufficient strength for the high loads that arise in practical use. The support element is preferably made from steel, particularly preferably from stainless steel, in particular from a stainless steel with the material grade number 1.4301 (according to DIN EN 10088-3). This material is distinguished by a low thermal conductivity and an almost consistent strength up to temperatures in the region of 500° C. The support element is preferably made from a material having a thermal conductivity of less than 20 W/(m·K).

Apart from the support element, the insulating element is also relevant to the mechanical stability, since said insulating element ensures the transmission of force between the first foot support, the foot support of the support element, and the second foot support. The insulating element is preferably resistant to pressure by way of a cold-pressure resistance (according to DIN EN 826) of at least 10 N/mm². The insulating element can be designed so as to be integral or in multiple parts. Said insulating element can be made from a uniform material or from dissimilar materials. The use of the term “insulating element” in the singular does not infer any restriction to that end. The insulating element preferably has a thermal conductivity of less than 0.5 W/(m·K). Preferred materials for the insulating element include calcium silicates, high-temperature-resistant polymers, laminates based on glass fibers, and high-temperature-resistant polymers or laminates based on insulation materials such as mica fractions and impregnated silicone resins.

In one preferred embodiment the insulating element is constructed as a multi-tiered composite, wherein insulating layers having a low thermal conductivity alternate with stabilizing layers from a pressure-resistant material.

The foot support, the insulating element, and the support element can be dissimilarly dimensioned, depending on the requirement. However, the pipe holder in the cross section perpendicular to the pipe axis preferably has a symmetrical construction.

The foot supports, the insulating element, and the support element are connected to one another by way of at least one fastening element. The at least one fastening element, or the plurality of fastening elements, can be selected from conventional construction elements that are suitable for fastening, for example rivets, screw connections, welded connections. The fastening elements are preferably screw connections. The insulating element and the support element between the two foot supports are preferably clamped by way of a tightening torque of at least 100 Nm.

The at least one fastening element preferably does not contact the foot part of the support element so as to avoid any direct heat transfer from the support element to the foot supports by way of the fastening element. In the case of rod-shaped fastening elements such as screws or rivets this can be ensured in that the bores in the support element are chosen so as to be larger than the diameter of the fastening element. Alternatively, sleeves which are produced from a thermally insulating material can be used.

It is furthermore preferable for a thermal insulation, for example in the form of thermally insulating washers in the case of screws as fastening elements, to be provided between the at least one fastening element and the foot supports.

In one preferred design embodiment of the pipe holder according to the invention the two foot supports have in each case one first face which is capable of being connected to the bearing, as well as in each case one second face which extends in the direction of the pipe so as to be substantially perpendicular to the first face.

“Substantially” in this context means that the angle between the first face and the second face does not have to be exactly 90°. Minor deviations for example by up to +/−5°, are still considered to be “substantially perpendicular” and thus included in said preferred design embodiment.

Examples of foot supports designed in such a manner are angled or profiled elements which in the cross section have an L-profile, T-profile, H-profile, a square profile, or similar profiles. With a view to an ideally minor investment in terms of material at a simultaneously high mechanical stability, the foot supports are preferably designed as an L-profile. An arrangement in which the second faces of the foot supports run so as to be substantially parallel and, on account thereof, form the intermediate space, and the first faces of the foot supports extend in each case from the intermediate space outward, is particularly preferred herein.

The foot supports are preferably made from a material having a high mechanical load capacity, for example from polymers or steels such as ferritic or chromium-nickel steels. The material property of the thermal conductivity is of lesser relevance in the selection for the foot supports, since the design embodiment of the tube holder according to the invention largely prevents any heat transfer from the pipeline to the foot supports.

The foot supports can be fastened to the bearing by way of usual force-fitting, form-fitting, or materially integral connection means, for example by way of claws, screw connections, rivets, or by welding.

The foot part of the support element is connected to the foot supports by way of the insulating element. The constructive design embodiment of said foot part thus influences the mechanical properties in terms of the transmission of force from the pipeline to the bearing.

The foot part of the support element is preferably embodied as an angled profile having a first face which runs so as to be substantially parallel to the bearing, and a second face which extends so as to be substantially perpendicular to the first face and so as to be substantially parallel to the pipe axis. The angled profile is particularly preferably an L-profile or a T-profile, in particular a T-profile. The design embodiment of the foot part of the support element as an angled profile when interacting with the insulating element, in relation to which said foot part is braced, causes an increased rigidity and an improved absorption of force in all load directions.

In the case of a design embodiment of the foot part of the support element as an angled profile it is preferable for the insulating element to be dimensioned in such a manner that the foot part upon fastening does not directly contact the internal sides of the foot supports in order for any heat transmission to be avoided. The spacing between the first face of the foot part of the support element and the internal side of the respective foot support is preferably at least 1 mm.

The pipe receptacle, the web, and the foot part, as component parts of the support element, can be connected to one another in various ways. Said pipe receptacle, said web, and said foot part are configured according to the invention so as to be integral, for example from a solid material, or so as to be connected to one another in a materially integral manner, for example by welding. Combinations of an integral embodiment and a materially integral embodiment as a connection are possible, for example an integral configuration of the web and the foot part, and a pipe receptacle that is connected in a materially integral manner at the upper end of the web. The pipe receptacle, the web, and/or the foot part can in each case also be formed from a plurality of individual parts which are connected to one another in a materially integral manner.

In one advantageous embodiment of the pipe holder according to the invention the connection between the foot part and the pipe receptacle of the support element is formed as a web by a substantially planar component. “Substantially” to this end is to be understood such that a component having uneven features or minor elevations or depressions is still considered to be “planar”. A flat-steel bar is an example of a planar component. The face of the web is preferably kept as small as possible. The construction and the dimensioning of the web can be designed so as to correspond to the requirements in terms of the absorption of force, for example by way of the shaping of the web in the axial direction as a rectangle or as a trapezoid, for example. Apart from a minor consumption of material and complexity in terms of processing, a minor heat transfer to the environment is a further advantage of this design embodiment. The web and the foot part can furthermore be mutually adapted and optimized in such a manner that a high mechanical stability is achieved at a minor heat loss by way of the pipe holder. This variant is particularly suitable when the pipe holder is loaded predominantly in the axial direction and has to receive hardly any transverse loads.

An alternative advantageous embodiment of the pipe holder according to the invention in which the connection between the foot part and the pipe receptacle of the support element is formed as a web by a component having an angled profile is suitable for applications in which significant transverse loads can also arise. The angled profile can be, for example, an L-profile, T-profile, H-profile, square profile, or a similar profile. An L-profile or a T-profile is preferred, a T-profile being particularly preferred.

In the case of an embodiment in which the foot part of the support element is likewise configured as an angled profile having a first face which runs so as to be substantially parallel to the bearing, and a second face which extends so as to be substantially perpendicular to the first face and so as to be substantially parallel to the pipe axis, the connection between the foot part and the pipe receptacle of the support element is furthermore preferably formed as a web by a component having an angled profile having a first face which runs so as to be parallel to the second face of the foot part of the support element, and a second face which runs so as to be substantially perpendicular to the first face. Both the angled profile of the web as well as the angled profile of the foot part are preferably designed as an L-profile or T-profile, particularly preferably as a T-profile.

In one refinement of the pipe holder according to the invention the support element comprises two pipe receptacles for receiving the pipe in a bearing manner, wherein the two pipe receptacles are connected to one another by way of a common foot part. In terms of suitable and preferred design embodiments of the pipe receptacles and the connection of the latter to the foot part, reference is made to the explanations above pertaining to the pipe holder having only one pipe receptacle.

The foot part of the support element is particularly preferably configured as an angled profile having a first face which runs so as to be substantially parallel to the bearing, and a second face which extends so as to be substantially perpendicular to the first face and so as to be substantially parallel to the pipe axis, wherein the connection between the foot part and the respective pipe receptacle of the support element is in each case formed as webs by a component having an angled profile having a first face which runs so as to be parallel to the second face of the foot part of the support element, and a second face which runs so as to be substantially perpendicular to the first face.

The connecting webs most particularly preferably run in the direction of the pipe so as to be substantially perpendicular to the bearing and are mutually parallel such that the support element in the transverse view (perpendicular to the pipe axis) has a U-profile.

The first face of the angled profile of the foot part of the support element is preferably spaced apart from the bearing. The spacing is preferably 1 to 10 mm. The heat transfer from the pipe to the bearing by way of the support element can be reduced by way of this measure.

In the case of this design embodiment an insulating material which in particular has a thermal conductivity of less than 0.5 W/(m·K) is particularly preferably disposed in the space between the first face of the angled profile of the foot part of the support element and the bearing. On account thereof, the heat transfer from the pipe to the bearing by way of the support element can be further reduced.

In one furthermore preferred embodiment of the pipe holder according to the invention the second face of the foot support runs so as to be substantially parallel to the second face of the foot part of the support element, and the insulating element between the two second faces is clamped by way of a tightening torque of at least 100 Nm.

In one advantageous refinement of the pipe holder according to the invention the insulating element on the external faces thereof is surrounded by a casing. Depending on the specific application and the task set, the casing encloses the insulating element partially or completely.

Protection against weather influences, in particular moisture or aggressive media, is one advantage of the casing around the insulating element. In this case, the insulating element is preferably completely enclosed by the casing. Suitable plastics materials or metals such as stainless steel, galvanized steel, zinc or aluminum are preferred as materials for the casing.

A mechanical protection of the insulating element, for example in relation to shocks, impacts, or the like, is a further advantage of the casing. In this case, the insulating element is preferably at least partially enclosed by the casing.

A casing which is disposed between the insulating element and the respective foot support and which covers the insulating element at least farther than the foot support can furthermore be provided. The casing preferably covers the insulating element across the entire lateral face that faces the foot support. This embodiment has the advantage that the compressive forces that are applied by the fastening elements are distributed more uniformly across the insulating element, this preventing the potential risk of damage to the insulating element in the region of the foot support.

Pipelines are usually insulated using insulation material such as mineral wool or glass wool across the entire length of said pipelines, so as to keep the heat loss to the environment as low as possible. This insulation layer is usually held and protected against environmental influences by a tubular casing from metal. In one advantageous design embodiment of the pipe holder according to the invention, the insulating element is completely surrounded by a casing, and the casing is designed in such a manner that said casing adjoins the tubular casing of the pipeline in a sealing manner.

By contrast to the pipe holders known from the prior art, the pipe holder according to the invention has the advantage that the latter can absorb high mechanical loads in the axial as well as in the radial direction and the transverse direction and herein minimizes the heat transfer from the medium transported in the pipeline to the environment. The advantage increases the higher the temperature of the medium. The pipe holder can in particular also be used as a fixed bearing, since said pipe holder can fix the pipeline also in the axial direction. As opposed to what are hereunder referred to as so-called “standard holders” of the prior art, according to FIGS. 1 and 2, substantially lower heat losses, typically in the magnitude of at least 50% in the case of a double-bracket holder and at least 70% in the case of a single-bracket holder can be achieved at a comparable absorption of force on account of pipe holders according to the invention.

As opposed to many pipe holders known from the prior art, the foot part of the support element in the case of the pipe holder according to the invention, in terms of the extent of said foot part, is freely selectable in wide ranges, since there are hardly any restrictions in terms of the construction of said foot part. This design freedom, while taking into account the condition according to the invention pertaining to the ratio of the bearing face of the insulating element on the foot part and the cold-pressure resistance of the insulating element, enables a stability that is adequate for the respective absorption of force required to be ensured and simultaneously an insulating material having a low heat loss to be able to be selected. A good compromise between the absorption of force and heat insulation can thus be in each case found individually for all relevant fields of application in process technology, this to date not having been possible to this extent using pipe holders known in the prior art. A lower surface temperature on the bearing can be achieved by virtue of the reduced heat transfer from the medium transported in the pipeline to the bearing to which the pipe holder is fastened, this being of great interest in particular with a view to the use of the holder in explosive environments.

The invention will be explained in more detail hereunder with reference to the drawings. The drawings are to be understood to be schematic illustrations. Said drawings do not represent any limitation of the invention, for example with a view to specific dimensions or variants of design embodiments. In the drawings:

FIG. 1: shows a cross section and a plan view of a single-bracket standard holder according to the prior art;

FIG. 2: shows a cross section and a plan view of a double-bracket standard holder according to the prior art;

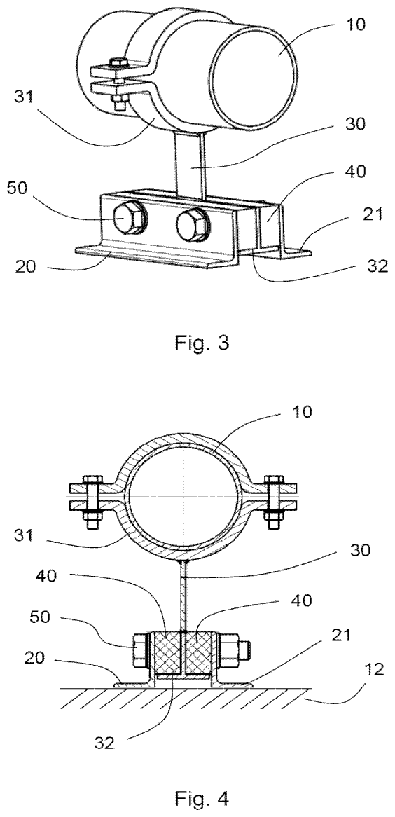

FIG. 3: shows a view of a first embodiment of a pipe holder according to the invention;

FIG. 4: shows a cross section of the first embodiment according to FIG. 3;

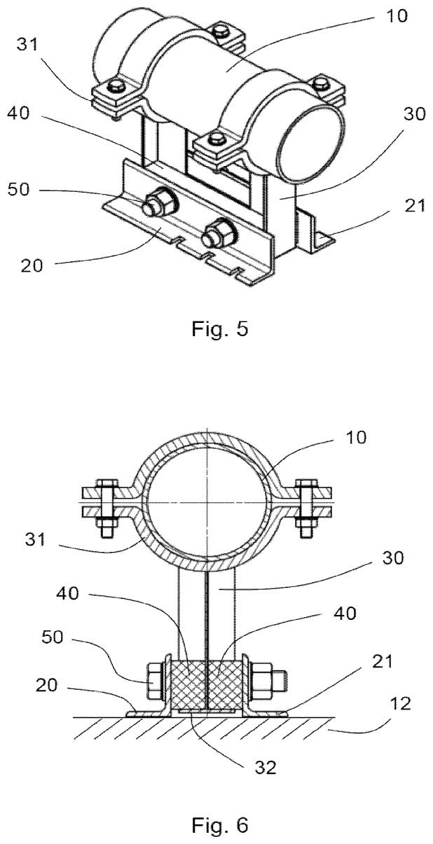

FIG. 5: shows a view of a second embodiment of a pipe holder according to the invention;

FIG. 6: shows a cross section of the second embodiment according to FIG. 5;

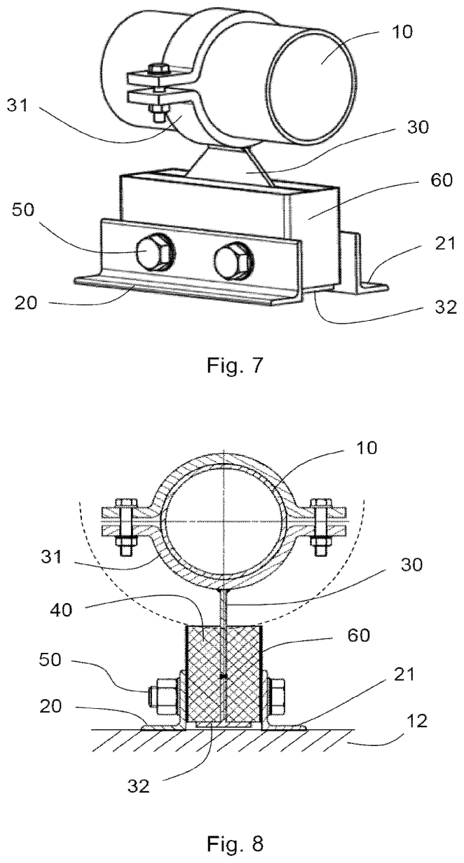

FIG. 7: shows a view of a third embodiment of a pipe holder according to the invention;

FIG. 8: shows a cross section of the third embodiment according to FIG. 7; and

FIG. 9: shows a limiting curve of the cold-pressure resistance as a function of the bearing face of the insulating element on the foot part.

### LIST OF REFERENCE SIGNS USED

10 . . . Pipe

12 . . . Bearing

20 . . . First foot support

21 . . . Second foot support

30 . . . Web of the support element

31 . . . Pipe receptacle of the support element

32 . . . Foot part of the support element

40 . . . Insulating element

50 . . . Fastening element

60 . . . Casing

FIG. 1 shows a single-bracket standard holder according to the prior art in the cross section (left) and in the plan view (right). The pipe holder comprises a support element having a web 30, the upper end of the latter being connected to a pipe bracket according to the prior art as a pipe receptacle 31. The pipe 10 to be mounted is enclosed by the pipe bracket. The web 30 at the lower end thereof is connected to a foot part 32, wherein the web 30 and the foot part 32 in the cross section, thus perpendicular to the pipe profile, form a T-profile. The pipe holder in the example illustrated is fastened to a T-support as the bearing 12. This corresponds to a situation that is often encountered in practice, in which the pipe holder is fastened to supports of a pipe bridge, for example. The fastening of the pipe holder to the bearing 12 is performed by way of a clamping part which is braced both on the foot part 32 as well as on the bearing 12. By virtue of the fact that the support element, the clamping part, and the bearing are usually made from a steel and all components are in direct mutual contact, the standard holder has a high heat loss when the temperature of the medium flowing in the pipe deviates significantly from the ambient temperature around the bearing 12. However, the direct contact of the component has a positive effect in terms of the forces to be absorbed, since the standard holder is suitable for absorbing forces both in the axial direction (indicated by Fx in FIG. 1) and in the radial direction (Fy), as well as forces in the vertical direction (Fz).

FIG. 2 shows a double-bracket standard holder according to the prior art in the cross section (left) and in the plan view (right). The construction in principle corresponds to that of the single-bracket holder illustrated in FIG. 1, but with the difference that the upper end of the web 30 is connected to two separate pipe brackets as pipe receptacles 31, and the web 30 is configured as a rectangular plate instead of the trapezoidal shape.

FIG. 3, in a three-dimensional view, diagrammatically shows a first embodiment of the pipe holder according to the invention for mounting a pipe 10 on a bearing 12. FIG. 4 shows the pipe holder according to FIG. 3 in the cross section perpendicular to the pipe axis. The pipe holder comprises a first foot support 20 and a second foot support 21 which are mutually spaced apart. Both foot supports are in each case capable of being connected to the bearing 12, for example capable of being screw-fitted. The pipe holder comprises a support element having a web 30, a pipe receptacle 31 at the upper end of the web, and a foot part 32 at the lower end of the web. The pipe receptacle 31 in the illustrated embodiment is designed as a two-part pipe bracket for receiving the pipe 10 in a bearing manner, wherein the lower half of the pipe bracket is connected in a materially integral manner to the web 30 of the support element, in the example illustrated is welded to the latter. The web 30 is configured as a substantially planar component.

The foot part 32 of the support element is disposed in the intermediate space between the two foot supports 20, 21. The foot part 32 of the support element is embodied as an angled profile in the form of a T-profile, having a first face which runs so as to be substantially parallel to the bearing 12, and a second face which extends so as to be substantially perpendicular to the first face and so as to be substantially parallel to the pipe axis. The first phase of the angled profile is spaced apart from the bearing 12. The foot part 32 is connected in a materially integral manner to the web 30, in the example illustrated is welded to the latter.

The pipe holder furthermore comprises a pressure-resistant insulating element 40 which in the embodiment illustrated is in two parts, wherein one part of the insulating element 40 is in each case disposed between the first foot support 20 and the foot part 32, as well as between the second foot support 21 and the foot part 32.

The foot supports 20, 21, the two parts of the insulating element 40, and the foot part 32 are connected to one another in a force-fitting manner by two screws as fastening elements 50.

The two parts of the insulating element 40 are dimensioned such that said two parts just fill the space between the first face of the angled profile of the foot part 32 of the support element and the upper edges of the foot supports 20, 21. The dimension of the two parts of the insulating element in the transverse direction is chosen such that the edges of the first face of the angled profile upon fastening do not directly contact the internal sides of the foot supports 20, 21. The choice of the spacing substantially depends on whether the main focus in the design of the pipe holder is on the thermal decoupling or mechanical stability. To this end, a compromise is typically to be reached, since a minor spacing means better mechanical stability but also a higher heat transfer than in the case of a larger spacing. In the example illustrated, a minor spacing has been chosen, and the pipe holder has thus been optimized with a view to mechanical stability.

The bearing face (A in [mm²]) of the insulating element 40 on the foot part 32 is dimensioned such that said bearing face meets the condition K>3·10⁶·A^{(-1.39)}, wherein “K” refers to the cold-pressure resistance (in [N/mm²]) of the chosen insulating element. Typical values for the cold-pressure resistance are, for example, 27 N/mm² in the case of calcium silicate, approx. 300 N/mm² in the case of laminates based on glass fibers which are bonded by way of the high-temperature resistant-polymer, as well as approx. 400 N/mm² in the case of insulation materials which are compressed to form laminates and which as substantial component parts comprise mica fractions in conjunction with impregnated silicone-resins.

FIG. 5, in a three-dimensional view, diagrammatically shows a second embodiment of the pipe holder according to the invention for mounting a pipe 10 on a bearing. FIG. 6 shows the pipe holder according to FIG. 5 in the cross section perpendicular to the pipe axis. By contrast to the pipe holder according to FIGS. 3 and 4, the support element in the case of this embodiment comprises two pipe receptacles 31 for receiving the pipe 10 in a bearing manner. The two pipe receptacles 31 are connected to one another by way of a common foot part 32. The foot part 32, like in the case of the pipe holder according to FIGS. 3 and 4, is designed as an angled profile in the form of a T-profile. The webs 30 as the connection between the foot part 32 and the respective pipe receptacle 31 of the support element are likewise designed as an angled profile in the form of a T-profile, wherein the respective face proportions of the foot part 32 and of the webs 30 are connected to one another in a materially integral manner, in the example illustrated are welded to one another. The two webs 30 of the support element run in the direction of the pipe 10 so as to be substantially perpendicular to the bearing 12 and are mutually parallel such that the support element in the transverse view (perpendicular to the pipe axis) has a U-profile.

In a manner similar to the pipe holder according to FIGS. 3 and 4, the pipe holder illustrated in FIG. 5 comprises a two-part, pressure-resistant, insulating element 40, wherein a part of the insulating element 40 is in each case disposed between the first foot support 20 and the foot part 32 of the support element as well as between the second foot support 21 and the foot part 32 of the support element. The dimensioning of the two parts of the insulating element 40 corresponds to that described in the context of FIGS. 3 and 4, so that this pipe holder is also conceived with a view to an ideally high mechanical stability. This pipe holder, by virtue of the double T-support structure, is also suitable for absorbing high transverse loads.

FIG. 7, in a three-dimensional view, diagrammatically shows a third embodiment of the pipe holder according to the invention for mounting a pipe 10 on a bearing. FIG. 8 shows the pipe holder according to FIG. 7 in the cross section perpendicular to the pipe axis. The pipe holder according to this embodiment, in terms of the construction thereof, is similar to the pipe holder shown in FIGS. 3 and 4, with the difference that the web 30 of the support element in the longitudinal direction of the pipe is designed so as to be wider, wherein this is likewise a substantially planar component.

This embodiment also comprises a two-part, pressure-resistant, insulating element 40, wherein a part of the insulating element 40 is in each case disposed between the first foot support 20 and the foot part 32 as well as between the second foot support 21 and the foot part 32 of the support element. The insulating element on the external faces thereof is surrounded by a casing 60 which in this example is produced from a steel sheet. The casing 60 completely encloses the insulating element 40 in the longitudinal and transverse direction of the pipe. The insulating element toward the top is not enclosed by the casing since the pipe holder in this example is provided so as to be surrounded by a pipe insulation. The insulation layer around the pipe as well as the tubular casing of the insulation layer are not illustrated in FIG. 8 but only indicated by the arc in dashed lines. Upon completion of the pipe casing the latter adjoins the casing 40 of the insulating element in a sealing manner such that the insulating element 40 of the pipe holder according to the invention is protected against weather influences or other types of damage.

### EXAMPLE 1: SINGLE-BRACKET PIPE HOLDER

A single-bracket pipe holder according to the invention and according to the embodiment illustrated in FIGS. 3 and 4, in terms of the thermal properties thereof, was compared with a standard holder according to FIG. 1, known from the prior art. Said single-bracket pipe holder according to the invention was furthermore compared with a corresponding pipe holder according to the teaching of first and unexamined publication DE 10 2014 109 599 A1 according to FIG. 2 in the latter, hereunder referred to as the “insulated holder”.

In the description of the pipe holders, for all components hereunder the term “length” is used for the extent of said pipe holders in the axial pipe direction, the term “width” is used for the radial extent perpendicular to the length, and the term “height” is used for the extent in the direction of the pipe 10 in the vertical direction from the bearing 12.

The standard holder was made from steel having a material thickness of 10 mm. The length of the foot part 32 was 250 mm, the length thereof 100 mm. The web 30 was designed so as to be trapezoidal having a height of 150 mm, a length on the foot part of 250 mm, and a length on the pipe bracket of 50 mm. The pipe bracket had a length of 50 mm at dissimilar diameters for the dissimilar nominal widths of the pipe holders tested.

The single-bracket pipe holder according to the invention, in terms of the construction thereof, corresponded to the embodiment illustrated in FIGS. 3 and 4. The web 30 had a height of 80 mm and a length of 50 mm. The length of the pipe bracket as the pipe receptacle 31 was likewise 50 mm. The foot part 32 was made from a T-profile having a width and height of 50 mm in a length of 210 mm. The pipe receptacle, the web, and the foot part were in each case produced from steel having a material thickness of 5 mm and were connected to one another in a materially integral manner by welding. L-profiles from steel, having a material thickness of 5 mm, which were in each case 250 mm long, 60 mm high, and 40 mm wide were used as foot supports 20, 21. An insulating element 40 from calcium silicate having a length of 210 mm, a width of 30 mm, and a height of 45 mm was in each case inserted between the foot supports and the foot part. The foot supports, the insulating elements, and the foot part were connected by two screws as fastening elements 50, having a tightening torque of in each case 100 Nm per screw. The bearing face of the insulating element at the foot part was 9450 mm². The cold-pressure resistance of the insulating elements was 27 N/mm².

The insulated holder according to the prior art tested, in terms of the construction thereof, corresponded to the holder shown in FIGS. 1 and 2 of document DE 10 2014 109 599 A1. In the case of this holder, the support element is composed of two separate formed parts which are punched from a steel sheet and are bent in such a manner that the upper ends of the formed parts form in each case one half of the pipe receptacle. In order for the support element to be formed, the two formed parts by way of recesses at the height level of the pipe receptacle are assembled so as to be folded into one another. The web which transitions seamlessly into the foot part adjoins the pipe receptacle. That part of the formed part which in the installed state is overlapped by the foot supports is to be considered the foot part. The material thickness of the steel sheets of which the formed parts were composed was 3 mm, so that the web and the foot part in the installed state had a total material thickness of 6 mm. The height of the web was 65 mm, and the height of the foot part 55 mm, at a length of 85 mm. The length of the pipe receptacle was likewise 85 mm. The foot supports were configured as L-profiles having a height of 85 mm and a width of 45 mm. An insulating element of calcium silicate having a length of 75 mm, a width of 20 mm, and a height of 75 mm was in each case inserted between the foot supports and the foot part.

The determination of the thermal properties, in particular the heat losses to be attributed to the pipe holders, was performed at a pipe testing station. The heat losses on various pipe specimens having dissimilar nominal widths at dissimilar temperatures were ascertained first. To this end, the respective pipe specimen was insulated using mineral-wool insulating shells having a thermal conductivity according to the AGI limiting curve 4. As a comparison basis, the heat losses by way of the pipe shells without a pipe holder were ascertained.

The pipe holders to be tested were subsequently fastened in each case separately to the pipe specimens, the mineral-wool insulation was attached again, and the heat loss was again ascertained. The heat loss (in Watt) of the respective pipe holder was then derived from the difference of the heat loss measured reduced by the initially ascertained heat loss of the pipe specimen by way of the pipe shells without the pipe holder. The values are stated in the following table. The ambient temperature during the measurements was 20° C.

| | Nominal | Heat loss by way of holder [W] | | |
|---|---|---|---|---|
| Holder | width | T = 100° C. | T = 200° C. | T = 300° C. |
| Standard holder | DN 100 | 9.4 | 24.6 | 36.0 |
| Insulated holder | DN 100 | 3.9 | 14.4 | 23.7 |
| According to the | DN 100 | 0.4 | 4.1 | 6.4 |
| invention | | | | |
| Standard holder | DN 25 | 12.9 | 32.9 | 56.4 |
| According to the | DN 25 | 3.9 | 12.9 | 23.4 |
| invention | | | | |

### EXAMPLE 2: DOUBLE-BRACKET PIPE HOLDER

In a further series of tests, a double-bracket pipe holder according to the invention according to the embodiment illustrated in FIGS. 5 and 6 was compared with a corresponding double-bracket standard holder according to FIG. 2. Said double-bracket pipe holder according to the invention was furthermore compared with a corresponding pipe holder according to the teaching of first and unexamined publication DE 10 2014 109 599 A1 according to FIG. 3 therein, hereunder referred to as the “insulated holder”.

The standard holder was made from steel having a material thickness of 10 mm. The length of the foot part 32 was 250 mm, the width thereof 100 mm. The web 30 was designed so as to be rectangular having a height of 150 mm and a length of 250 mm. A pipe bracket as a pipe receptacle was in each case attached in the axial direction on both ends of the web. The pipe brackets had in each case a length of 50 mm at dissimilar diameters for the dissimilar nominal widths of the pipe holders tested.

The double-bracket pipe holder according to the invention, in terms of the construction thereof, corresponded to the embodiment illustrated in FIGS. 5 and 6. The pipe holder comprised two pipe brackets as pipe receptacles 31 which had in each case a length of 50 mm. The two pipe receptacles were connected by in each case one T-profile of the dimensions 50×50×6 mm as the web, having a common T-profile of the dimensions 50×50×6 mm as the foot part. The three T-profiles were made from steel and were connected in a materially integral manner both to one another as well as to the pipe brackets by welding. The length of the foot part was 210 mm, the web length 80 mm. L-profiles from steel having a material thickness of 6 mm, which were in each case 250 mm long, 60 mm high and 40 mm wide, were used as foot supports 20, 21. An insulating element 40 of calcium silicate, having a length of 210 mm, a width of 30 mm and a height of 45 mm, was in each case inserted between the foot supports and the foot part. The foot supports, the insulating elements, and the foot part, deviating from the illustration in FIG. 5, were connected by three screws as fasting elements 50, having a tightening torque of in each case 100 Nm per screw. The bearing face of the insulating element on the foot part was 9450 mm². The cold-pressure resistance of the insulating elements was 27 N/mm².

The insulated holder according to the prior art tested, in terms of the construction thereof, corresponded to the holder shown in FIG. 3 of document DE 10 2014 109 599 A1. The embodiment of the formed parts corresponded to that described above in the context of the single-bracket holder, so that the double-bracket holder differed from the single-bracket holder only in terms of the number of formed parts as well as the length of the foot supports.

The procedure in ascertaining the heat losses corresponded to that described in the context of example 1 above. The results are reproduced in the table below.

| | Nominal | Heat loss by way of holder [W] | | |
|---|---|---|---|---|
| Holder | width | T = 100° C. | T = 200° C. | T = 300° C. |
| Standard holder | DN 100 | 11.6 | 30.9 | 46.8 |
| Insulated holder | DN 100 | 8.5 | 25.2 | 41.6 |
| According to the | DN 100 | 5.5 | 17.4 | 27.4 |
| invention | | | | |

In a further series of tests, the pipe holders were however checked as to what maximum forces said pipe holders can absorb in the axial pipe direction (Fx) and in the radial direction (Fy). To this end, the holders were in each case fixedly screw-fitted to a bearing and a force either in the axial or the radial direction was exerted on the pipe clamped in the holders. These experiments were carried out at a media temperature of 300° C.

The table hereunder reproduces the maximum forces (in kN) before a mechanical failure of the respective holders occurred:

| Force [kN] | Fx | Fy |
|---|---|---|
| Insulated holder | 24.6 | 11.0 |
| According to the | 49.6 | 18.5 |
| invention | | |

Both the single-bracket as well as the double-bracket pipe holder according to the invention in relation to holders known from the prior art are distinguished by a significantly higher absorption of forces at a simultaneously improved thermal insulation.

1. A pipe holder for mounting a pipe on a bearing, comprising:
two foot supports which are mutually spaced apart and are in each case capable of being connected to the bearing;
a support element having a web, a pipe receptacle at the upper end of the web, and a foot part at the lower end of the web, wherein the pipe receptacle, the web, and the foot part are configured so as to be integral or are connected to one another in a materially integral manner, and wherein the foot part is disposed in the intermediate space between the foot supports;
at least one pressure-resistant insulating element which is disposed between the first foot support and the foot part as well as between the second foot support and the foot part,
wherein the foot supports, the insulating element, and the foot part are connected to one another in a force-fitting manner by way of at least one fastening element, and the pipe holder is conceived for withstanding a breaking load (according to appendix J of DIN EN 13480-3:2013-11) of at least 2.8 kN, wherein the bearing face (A in [mm²]) of the insulating element on the foot part and the cold-pressure resistance (K in [N/mm²]) of the insulating element meet the condition K>3·10⁶·A^{(-1.39)}.

2. The pipe holder according to claim 1, wherein the two foot supports have in each case one first face which is capable of being connected to the bearing, as well as in each case one second face which extends in the direction of the pipe so as to be substantially perpendicular to the first face.

3. The pipe holder according to claim 1, wherein the foot part of the support element is embodied as an angled profile having a first face which runs so as to be substantially parallel to the bearing, and a second face which extends so as to be substantially perpendicular to the first face and so as to be substantially parallel to the pipe axis.

4. The pipe holder according to claim 3, wherein the connection between the foot part and the pipe receptacle of the support element is formed as a web by a substantially planar component.

5. The pipe holder according to claim 3, wherein the connection between the foot part and the pipe receptacle of the support element is formed as a web by a component having an angled profile having a first face which runs so as to be parallel to the second face of the foot part of the support element, and a second face which runs so as to be substantially perpendicular to the first face.

6. The pipe holder according to claim 1, wherein the support element comprises two pipe receptacles for receiving the pipe in a bearing manner, said pipe receptacles being connected to one another by way of a common foot part.

7. The pipe holder according to claim 6, wherein the foot part of the support element is configured as an angled profile having a first face which runs so as to be substantially parallel to the bearing, and a second face which extends so as to be substantially perpendicular to the first face and so as to be substantially parallel to the pipe axis, and wherein the connection between the foot part and the respective pipe receptacle of the support element is in each case formed as webs by a component having an angled profile having a first face which runs so as to be parallel to the second face of the foot part of the support element, and a second face which runs so as to be substantially perpendicular to the first face.

8. The pipe holder according to claim 3, wherein the first face of the angled profile of the foot part of the support element is spaced apart from the bearing.

9. The pipe holder according to claim 3, wherein the second face of the foot support runs so as to be substantially parallel to the second face of the foot part of the support element, and wherein the insulating element between the two second faces is clamped by way of a tightening torque of at least 100 Nm.

10. The pipe holder according to claim 1, wherein the insulating element on the external faces thereof is at least partially surrounded by a casing.

11. The pipe holder according to claim 1, which is conceived for withstanding a breaking load (according to appendix J of DIN EN 13480-3:2013-11) of at least 6.4 kN, wherein the bearing face (A in [mm²]) of the insulating element on the foot part and the cold-pressure resistance (K in [N/mm²]) of the insulating element meet the condition K>2·10⁶·A^{(-1.28)}.
